(19) United States
(12) Patent Application Publication
(10) Pub. No.: US 2002/0183098 A1
(43) Pub. Date: Dec. 5, 2002

(54) Cellular phone with caller ID light arrangement

(76) Inventors: Yung-Tang Lee, Taipei (TW); Shih-Min Wang, Taipei (TW)

Correspondence Address: BIRCH STEWART KOLASCH & BIRCH, PO BOX 747, FALLS CHURCH, VA, 22040-0747, US

(21) Appl. No.: 09/838,163

(22) Filed: Apr. 20, 2001

(51) Int. Cl. H04M 1/00; H04B 1/38

(52) U.S. Cl. 455/566; 455/90; 455/550

(57) ABSTRACT

A cellular phone is capable of showing a caller ID by light as long as the call ID feature is available by telephone services. A light emitting element is provided in one of a plurality of keys of an alphanumeric keypad of a conventional telephone or a cellular phone. The position of each light emitting element is recorded in a databank of the telephone. In use, one or more light emitting elements are lit. Then, a light emitting driver circuit may be activated to cause the lit light emitting element to even flash. It is possible to identify a calling party by recognizing the lit or flashed light emitting element(s).

### BACKGROUND OF THE INVENTION

1. Field of Invention

The present invention relates to cellular phones and more particularly to a cellular phone capable of showing a caller ID by a specific color of light or flashing.

2. Related Art

Cellular phones have evolved rather rapidly so that ever increasing number of people use it. Further, the functions of a cellular phone may incorporate features of many consumer electronic products to form a multifunctional cellular phone. For example, a cellular phone having built-in modem and installed communication software for accessing the Internet. It is also found by many cellular phone manufacturers that a cellular phone with a modern design and/or incorporated with light emitting feature may be more attractive to potential buyers, especially young people.

Recently, caller ID has been incorporated in telephone services. Thus, a called party may know the calling party when ringing if caller ID is available in a traditional telephone or a cellular phone. As to cellular phone, caller ID (i.e., the phone number of the calling party) is shown in a liquid crystal display (LCD). In an advanced model, the color of LCD may be changed (i.e., lit or dimmed) for showing a specific calling party. However, such designs are limited to LCD. This is unsatisfactory for the purpose for which the invention is concerned.

### SUMMARY OF THE INVENTION

It is therefore an object of the present invention to provide a cellular phone capable of showing a caller ID by lighting one or more keys.

It is another object of the present invention to provide a cellular phone wherein one or more keys of keypad corresponding to a specific caller ID is lit when ringing so as to be more attractive.

The advantages of the present invention are realized by providing a cellular phone comprising a light emitting device having a plurality of light emitting elements located in the keys. Hence, one or more light emitting elements may be lit, flashed, or even flashed in sequence for showing a specific caller ID when ringing so as to be more attractive.

The telephone of the invention may be either a traditional one or a cellular phone. Thus shown telephone number may be accessed from databank, a plurality of preset numbers, or caller ID. Each calling party is represented by a predetermined combination of keys incorporated with light emitting elements. Hence, it is possible to show a specific calling party by lighting a corresponding key or a combination of keys. Moreover, the appearance of a cellular phone according to the invention is fascinated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become fully understood from the detailed description given hereinbelow illustration only, and thus are not limitative of the present invention, and wherein:

FIG. 1 is a perspective view of a first preferred embodiment of cellular phone with caller ID light arrangement according to the invention;

FIG. 2 is a side view of FIG. 1 for illustrating the incorporation of light emitting element into a key in a first configuration;

FIG. 3 is an exploded perspective view of FIG. 1 for illustrating the incorporation of light emitting element into a key in a second configuration; and

FIG. 4 is a perspective view of a second preferred embodiment of cellular phone with caller ID light arrangement according to the invention.

### DETAILED DESCRIPTION OF THE INVENTION

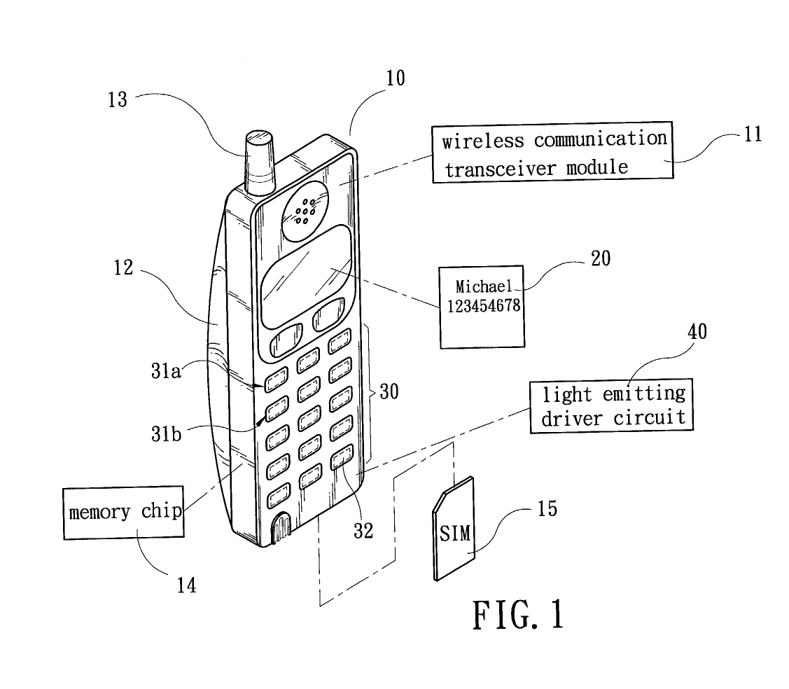

Referring to FIGS. 1 to 3, there is shown a first embodiment of cellular phone 10 constructed in accordance with the invention. Cellular phone 10 comprises a wireless communication transceiver module 11, a rechargeable battery 12, and an antenna 13. These components are the same as that provided by a conventional cellular phone. As to carry out the invention, it is necessary for cellular phone 10 to further comprise a databank 20, an alphanumeric keypad 30, and a light emitting driver circuit 40. Each of above three components is detailed below. Databank 20 is stored in a recording medium such as a subscriber identity module (SIM) or a memory chip 14 of cellular phone 10. Caller ID and corresponding light position (LP) are stored in databank 20 as shown in Table I below.

TABLE I

| caller ID | light position (LP) |
|---|---|
| 0900123456 | 1 |
| 0298765432 | 2 |
| 0412384543 | 3 |
| 0534123563 | 4 |

Keypad 30 comprises a plurality of keys (e.g., 31a, 31b, etc.) and a plurality of light emitting elements 32 each associated with a corresponding key. Also, a unique LP is designed to a respective light emitting element 32. Light emitting driver circuit 40 is activated to search a corresponding LP in databank 20 based on the received caller ID when ringing. One or more light emitting elements 32 corresponding to the matched LP are then lit by the light emitting driver circuit 40.

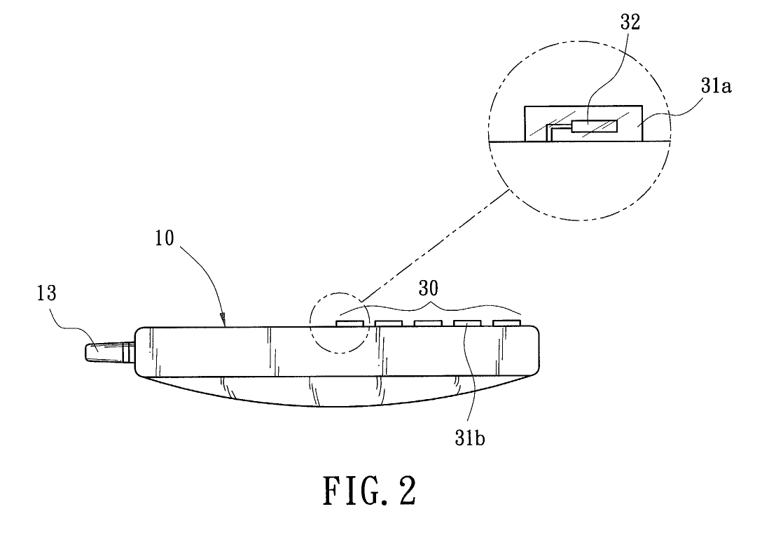

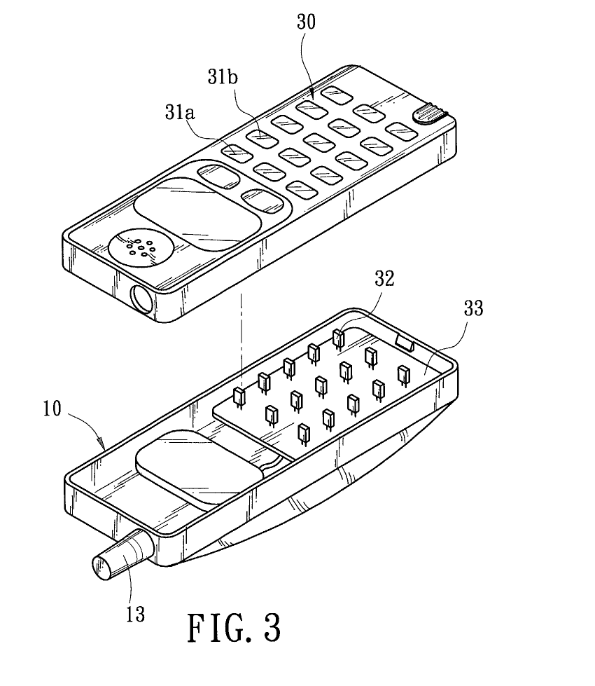

Basically, databank 20 is available from a typical cellular phone 10. Name or telephone number recorded in databank 20 is the data source of caller ID. Since caller ID (i.e., showing telephone number of calling party) has been incorporated in most telephone services it is preferred for LCD to show telephone number as caller ID when ringing. As to LP, it is corresponding to a key (e.g., 31a or 31b). As understood that, key may be a number key or a function key (e.g., * or #). Key (e.g., 31a, 31b, etc.) is transparent. Thus, keys may be formed of colorless plastic material or silicone resin. In a first configuration, light emitting elements 32 are mounted under keys (FIG. 2). In a second configuration, light emitting elements 32 are mounted on a circuit board 33 under the keypad 30 wherein each light emitting element 32 is associated with a corresponding key (FIG. 3). Light emitting element 32 may be a conventional light emitting diode (LED) having a single color. Alternatively, light emitting element 32 is implemented as LED having three primary colors. Thus, light emitting driver circuit 40 may be activated to cause one or more light emitting elements 32 to emit light of different colors for showing a specific calling party.

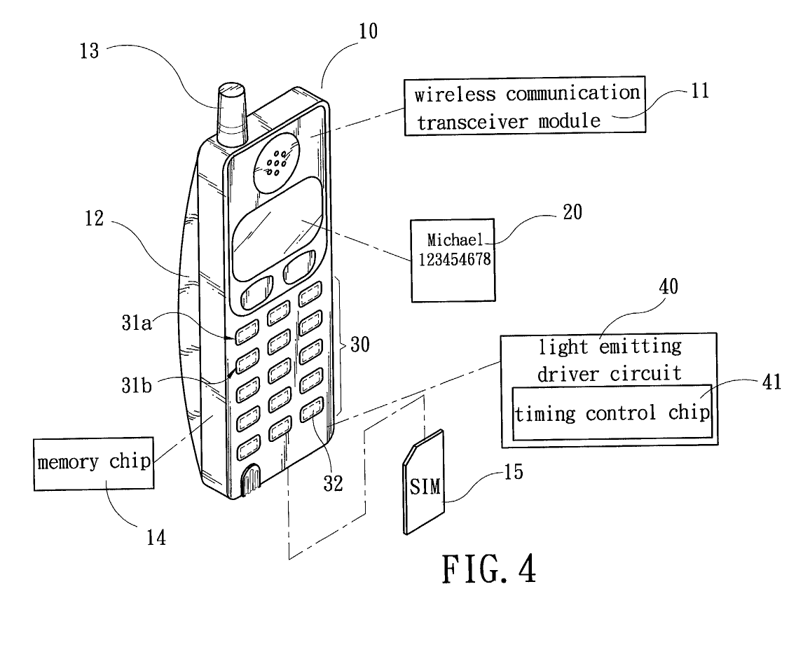

Referring to FIG. 4, there is shown a second embodiment of cellular phone 10 constructed in accordance with the invention. The difference between this and first embodiment is that a timing control chip 41 is incorporated in light emitting driver circuit 40 for driving all light emitting elements 32 to emit light in sequence. This brings a dynamic visual effect. Further, light emitting driver circuit 40 may be activated to cause one or more light emitting elements 32 to flash when ringing. Furthermore, light emitting driver circuit 40 may be activated to cause one or more light emitting elements 32 to emit light in one of following ways in which 1) a respective illuminated color represents a specific calling party, 2) a light emitting element 32 representing a specific calling party is flashed, while other remaining light emitting elements 32 are flashed in sequence, 3) a light emitting element 32 representing a specific calling party is lit in a single color but not flashing, while other remaining light emitting elements 32 are flashed in sequence, and 4) a light emitting element 32 representing a specific calling party is lit in a single color but not flashing, while other remaining light emitting elements 32 are flashed in sequence in a different color.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A caller ID light device for a cellular phone, said device comprising:
a databank stored in a recording medium having a plurality of caller IDs and a plurality of associated light positions;
an alphanumeric keypad comprising a plurality of transparent keys and a plurality of light emitting elements each associated with one of said keys and assigned with one of said light positions; and
a light emitting driver circuit for searching said corresponding light position in said databank based on said received caller ID and lighting at least one of said light emitting elements corresponding to said matched light position.

2. The device of claim 1, wherein said recording medium is a subscriber identity module (SIM).

3. The device of claim 1, wherein said recording medium is a memory chip.

4. The device of claim 1, wherein said call ID is a telephone number of a calling party.

5. The device of claim 1, wherein said keys are number keys.

6. The device of claim 1, wherein each of said light emitting elements is located within one of said keys.

7. The device of claim 1, wherein each of said light emitting elements is located under one of said keys.

8. The device of claim 1, wherein each of said light emitting elements is a light emitting diode (LED) having a single color.

9. The device of claim 1, wherein each of said light emitting elements is a light emitting diode (LED) having three primary colors.

10. The device of claim 1, wherein said light emitting driver circuit is operable to flash one of said light emitting elements.

11. The device of claim 1, wherein said light emitting driver circuit comprises a timing control chip for driving all of said light emitting elements to emit light in sequence.

12. The device of claim 1, wherein said light emitting driver circuit is operable to cause said light emitting elements to emit light having a variety of colors based on said received caller ID.
